(19) United States
(12) Patent Application Publication
(10) Pub. No.: US 2026/0228368 A1
(43) Pub. Date: Aug. 6, 2026

(54) DATA SECURITY SYSTEM WITH VERSATILE AUTHENTICATION AND MANAGEMENT

(71) Applicant: ClevX, LLC, Kirkland, WA (US)

(72) Inventors: Lev M. Bolotin, Kirkland, WA (US); Alex Lemelev, Maple (CA); Marc Singer, Seattle, WA (US)

(21) Appl. No.: 19/046,299

(22) Filed: Feb. 5, 2025

(51) Int. Cl. G06F 21/78; G06F 21/32; G06F 21/60

(52) U.S. Cl. CPC G06F 21/78; G06F 21/32; G06F 21/604

(57) ABSTRACT

A data security system (e.g., a secure storage device) with versatile authentication and management capabilities is disclosed. The described technology addresses the technical problem of providing secure data storage with multiple authentication methods and remote management capabilities. The data security system (DSS) comprises a storage media, an interface controller, an authentication controller, and an electronic switch. The authentication controller authenticates users to unlock the DSS and sets the electronic switch to connect the external data channel to either the authentication controller or the interface controller. The DSS supports various authentication methods, including keypad, phone-based, and host application authentication, allowing flexibility in different environments. The primary use of the described technology is to enhance data security and user flexibility, making the system suitable for organizations with specific security requirements. The system's architecture ensures secure transitions between authentication and data modes, providing robust security and adaptability.

### TECHNICAL FIELD

The subject matter disclosed herein generally relates to electronic devices and, more particularly, to data security systems and secure data storage devices.

### BACKGROUND

Security is a critical issue with almost all aspects of computer use. Storage media, such as hard disk drives attached to computers, contain valuable information that is vulnerable to data theft. A great deal of money and effort are being applied to safeguard personal, corporate, government, and private information, as well as content stored on data storage media (memory storage).

As external portable memory storage devices have become smaller, easier to lose, more ubiquitous, cheaper, and larger in memory capacity, they have come to pose extraordinary security problems. It is now possible to download massive amounts of information surreptitiously into portable memory storage devices, such as universal serial bus flash and micro drives, mobile phones, camcorders, digital cameras, iPods, MP3/4 players, tablets, palm and laptop computers, gaming equipment, authenticators, tokens (containing memory), etc. in general, a mass storage device (MSD), such as built-in (embedded) and external and portable connected to a computing device (host), a component of Edge AI, IoT devices, and various other devices, tools, instruments, and equipment and access control systems.

There is a problem for secure data storage and management arising from the need for a secure data storage (secure drive) system that can accommodate multiple authentication methods while providing remote management capabilities. The problem is characterized by the limitations of existing authentication methods, such as keypad and phone-based authentication. Keypad authentication is host-independent but difficult to configure due to limited interface options. Phone-based authentication is convenient but restricted in environments where phone usage is prohibited.

The problem is most important for secure drive systems used in environments with stringent security requirements. These systems require flexibility and versatility of available methods to configure and manage drives without relying solely on built-in keypads or phone-based methods. The impact of the problem is significant, as it affects the usability and security of the drive system. Users may face challenges in configuring and managing drives, leading to potential security vulnerabilities or operational inefficiencies.

Potential causes of the problem include the limited interface options of keypad authentication and the restrictions on phone usage in certain environments. Existing solutions have attempted to address these issues by providing separate methods for configuration and management, but they often lack integration and flexibility.

### BRIEF DESCRIPTION OF THE DRAWINGS

Various appended drawings illustrate examples of the present disclosure and cannot be considered limiting its scope.

FIG. 1 is a schematic of a Data Security System (DSS), according to some examples.

FIG. 2 is an illustration of an architecture for a self-encrypting drive (SED) situated inside a host computer system.

FIG. 3 is an illustration of different systems that allow the user to interact with the DSS.

FIG. 4 illustrates the interaction of a mobile device with a host computer system having an SED.

FIG. 5 is a flowchart of a method for user authentication, according to some examples.

FIG. 6 illustrates a management architecture for remote management of devices with encryption capabilities.

FIG. 7 illustrates the versatility of the DSS for authenticating a user before access is granted, according to some examples.

FIG. 8 is an exemplary data security communication system.

FIG. 9 is another data security communication system with an embedded SED, according to some examples.

FIG. 10 is an administrator sequencing diagram showing the sequence of operations between a device and the DSS, according to some examples.

FIG. 11 is an unlocking-sequence diagram using an external device as an authentication factor.

FIG. 12 is an unlocking-sequence diagram showing unlocking using a Personal Identification Number (PIN) entry from the external device.

FIG. 13 is an unlocking-sequence diagram showing unlock using a PIN entry and user ID/location/time verification via the server, according to some examples.

FIG. 14 is a reset sequencing diagram showing resetting the DSS using the server.

FIG. 15 is an unlocking-sequence diagram showing the unlocking of the data security system using the server/console.

FIG. 16 is a user interface for configuring drive operations, according to some examples.

FIG. 17 is a user interface for managing users of remote devices, according to some examples.

FIG. 18 is a user interface for setting time and geographic constraints on the use of devices.

FIG. 19 is a flow chart of a method for authenticating the DSS, according to some examples.

FIG. 20 is a block diagram illustrating an example of a machine upon or by which one or more process examples described herein may be implemented or controlled.

### DETAILED DESCRIPTION

Example methods, systems, and computer programs described herein are directed at a data security system (for example, a secure storage device) with versatile authentication and management capabilities. Examples merely typify possible variations. Unless explicitly stated otherwise, components and functions are optional and may be combined or subdivided, and operations may vary in sequence or be combined or subdivided. The following description provides numerous specific details to provide a thorough understanding of examples. However, it will be evident to one skilled in the art that the present subject matter may be practiced without these specific details.

The presented solution provides a method of configuration and operation of a secure device with configuration mechanisms and management. The method includes a Data Security System (DSS) with an authentication controller, an interface controller, and an electronic switch. The external data channel of the DSS is connected to the switch, which routes the communications to either the authentication controller or the interface controller. Thus, only one controller at a time is visible to the host connected to the DSS.

The solution described in the document pertains to a DDS that integrates multiple authentication methods and remote management capabilities. The system architecture includes a secure drive equipped with a USB switch, keypad, and transceiver, a host application that may run as a service on a computer, an authentication subsystem, a media controller with a built-in encryption engine for data encryption and decryption, and a remote management server for (remote) user authorization and drive access to provide additional layers of authentication and security, especially for the use within corporate environments.

The USB switch is configured to toggle between authentication and configuration and data modes. In its default mode, the switch connects the host application to the authentication subsystem. The authentication controller has control over the switch, ensuring secure transitions between modes. The host application is developed to run in the background, similar to antivirus software, and may integrate Single Sign-On (SSO) capabilities to utilize existing user credentials. It also facilitates communication with the remote management server for user authorization and to enable administrators and IT managers to have control over secure devices and authorized users, as well as geo-and time-fencing of the allowed usage of such devices.

The presented DSS supports multiple authentication methods, including keypad authentication, phone-based authentication using Bluetooth or other wireless communication, and host application authentication. These methods may be combined for double authentication (to deploy authentication solutions with multiple authentication mechanisms). This flexibility allows users to unlock the drive using various methods depending on their environment and restrictions, as well as to configure (e.g., provision) the drive with user and administrator PINs or passwords and to configure additional drive settings, e.g., drive-locking options, read-only, time-out lock, etc.

User authentication information, such as the user password or PIN, could be optionally securely stored on the server and recovered, if required by the user, using the user's email address or SMS (via mobile phone). Such a password recovery solution doesn't require the administrator's password or PIN and requires only access to the user's email or SMS.

Remote management capabilities are configured through a server setup that handles user authorizations and drive management. User roles and permissions are implemented on the server, and geolocation services are integrated to track drive usage and enforce location-based policies. Additionally, remote management can also be used for the drive's initial configuration and provisioning.

One benefit of this solution is its ability to provide robust security through multiple authentication methods while allowing remote management, thus offering flexibility and adaptability to various user environments. This approach ensures data security and user flexibility, making it suitable for organizations with specific security requirements.

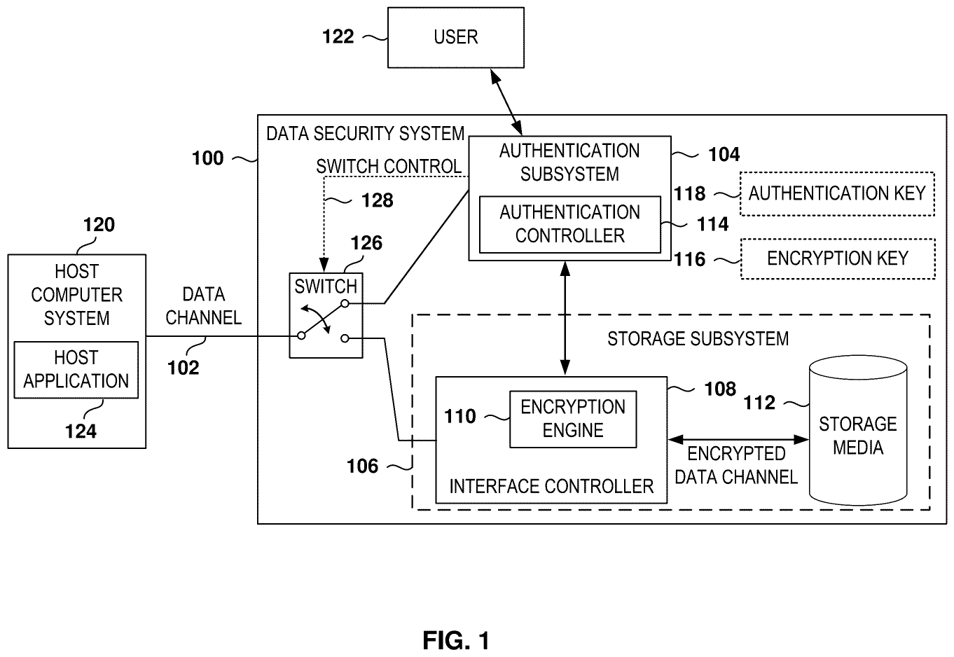

FIG. 1 is a schematic of a Data Security System (DSS 100), according to some examples. The system is connected to a host computer system 120, also referred to herein as host, via an external data channel 102, which facilitates communication between the DSS 100 and the host computer system 120. As used herein, a host computer system is a computer device comprising a computer processor and a communications interface to connect to the DSS 100. The host computer system may also be referred to herein as host, host system, computer device, or device. The host computer system 120 includes a host application 124 that interacts with the DSS 100.

The data security system 100 comprises an authentication subsystem 104 and a storage subsystem 106. The authentication subsystem 104 includes an authentication controller 114, which manages user authentication by verifying a user 122 using different authentication methods. Once the user is authenticated, the authentication controller 114 transmits an encryption key 116 to the storage subsystem 106. In some examples, the authentication controller 114 may have its own non-volatile memory, such as an electrically erasable programmable read-only memory (EEPROM).

The storage subsystem 106 contains an interface controller 108 that includes an encryption engine 110. The interface controller 108 manages data flow between the host computer system 120 and storage media 112. The interface controller 108 includes the encryption engine 110 (implemented in software or hardware), although the encryption engine 110 can be in a separate controller in the storage subsystem 106 in some examples. The encryption engine 110 encrypts and decrypts data as the data is written to or read from the storage media 112, ensuring that data remains secure during storage and transmission.

The storage media 112 can be an internal or external hard disk (HDD), spinning media drive, USB flash drive, solid-state drive (SSD), hybrid drive, memory card, tape or SSD/HDD cartridge, and optical media, including optical disk (e.g., Blu-ray disk, digital versatile disk or DVD, and compact disk or CD). The storage media 112 can include a data protection appliance, an archival storage system, and a cloud-based data storage system. The cloud storage system may be accessed utilizing a plug-in (or “plugin”) application or extension software installed in a browser application, either on the host computer or on another system coupled to the host computer via a wired or wireless network, such as RF or optical, or over the world wide web.

A switch 126, controlled by a switch control 128, is used to toggle the connection between the external data channel 102, coupled to the host computer system 120, and either the authentication subsystem 104 or the storage subsystem 106. This switch 126 ensures that only one subsystem is accessible to the host at any given time, enhancing the security of the data by preventing unauthorized access. It is noted that the switch 126 is shown as a separate component within the data security system 100, but in some examples, the switch 126 may also be incorporated within another components of the data security system 100.

The encrypted data channel is used to transmit encrypted data between the interface controller 108 and the storage media 112. This channel ensures that data remains secure during storage and retrieval operations.

In some examples, the data security system 100 can be configured to support multiple authentication methods, including keypad authentication, phone-based authentication, host application authentication, and biometric authentication. This flexibility allows the system to adapt to various user environments and security requirements for drive configuration and drive unlocking using direct input for the drive or using a remote management server.

When the DSS 100 is mounted to the host 120, the switch 126 is configured, by the authentication controller 114, to connect the external data channel 102 to the authentication controller 114. Thus, the host application 124 on the host computer system 120 is able to communicate with the authentication controller 114, such as to provide authentication information to the authentication controller 114.

After the user is authenticated, the authentication controller 114 changes the switch to connect the external data channel 102 to the interface controller 108, thereby giving the host computer system 120 access to the storage media 112.

The external data channel 102 provides a means of exchanging data with the host computer system 120. Universal Serial Bus (USB) is one of the most popular means to connect the data security system 100 to the host computer system 120. Other examples of the external data channel 102 include Firewire, wireless USB, Serial ATA (SATA), Peripheral Component Interconnect (PCI), Integrated Drive Electronics (IDE), Small Computer System Interface (SCSI), Industry Standard Architecture (ISA), Personal Computer Memory Card International Association (PCMCIA), Peripheral Component Interconnect Express (PCI Express), a switch fabric, High Definition Multimedia Interface (HDMI), Recommended Standard 232 (RS-232), and radio frequency wireless networks.

The interface controller 108 is capable of translating USB packet data to data that can be written to the storage media 112 in a USB flash-memory-based drive (or other types of data storage media). In some examples, the interface controller 108 is not operational until the authentication subsystem 104 has authenticated the user 122; that is, the encryption engine 110 will not encrypt or decrypt data, and the external data channel 102 will not transfer any data until the user 122 is authenticated.

The encryption engine 110 takes clear text or data from the host computer system 120 and converts it to an encrypted form that is written to the storage media 112. The encryption engine 110 also converts encrypted information from the storage media 112 and decrypts it to clear information for the host computer system 120. The encryption engine 110 can also be a two-controller subsystem with an encryption controller that has the encryption capability to encrypt/decrypt data on the fly along with managing the communication protocol, memory, and other operating conditions, and a communication/security controller for handling the communication, encryption key management, and communications with the encryption controller.

An encryption key 116 is required by the encryption engine 110 to encrypt and decrypt information. In some examples, the encryption key 116 is used in an algorithm (e.g., a 256-bit Advanced Encryption Standard (AES) encryption) that respectively encrypts/decrypts the data by an encryption algorithm to render data unreadable or readable. The encryption key 116 can be stored inside or outside the authentication controller 114.

The encryption key 116 is transmitted to the encryption engine 110 by the authentication subsystem 104 once a user 122 (e.g., having an identification number or key) has been verified against the authentication key 118.

When the data security system 100 is locked, the authentication key 118 remains inside the authentication subsystem 104 and cannot be read from outside. One method of hiding the authentication key 118 is to store it in the authentication controller 114 in the authentication subsystem 104. Setting the security fuse of the authentication controller 114 makes it impossible to access the authentication key 118 unless the authentication controller 114 allows retrieval once the user 122 has been verified.

In some examples, the authentication key 118 can be used in several capacities: 1. As the encryption key 116 to encrypt/decrypt the information directly. 2. As a key to recover the encryption key 116 stored in the data security system 100 that can be accessed by the interface controller 108. 3. Used for direct comparison by the interface controller 108 to activate the external data channel 102.

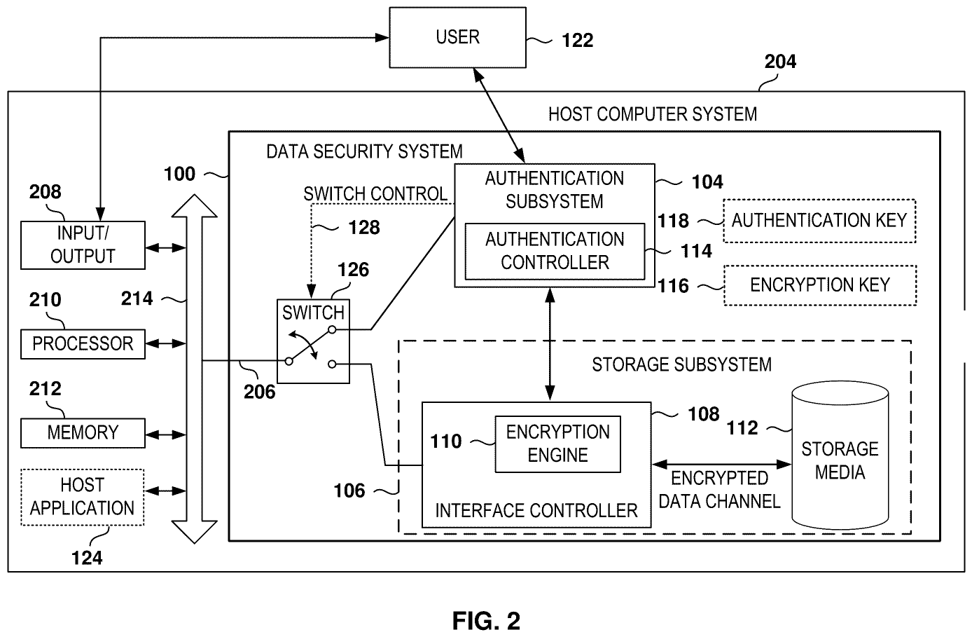

FIG. 2 is an illustration of an architecture for a self-encrypting drive (SED) situated inside a host computer system 204. In some examples, the DSS 100 is configured to be installed within a host computer system 204. In this configuration, the DSS is also referred to as the self-encrypting drive (SED). In some examples, the host OS system runs from a different drive, and the user data would be stored on the SED for data protection.

In this example, the DSS 100 is configured as described above with reference to FIG. 1. The switch 126 is connected to a computer bus 214 to enable communications between the DSS 100 and the components of the host computer system 204. The host computer system 204 includes input/output 208, a processor 210, and memory 212. The host application 124 may reside in the memory 212 and execute on the processor 210.

The data security system 100 is being used as a self-encrypting drive, and the data security system 100 interfaces directly with the user 122 for authenticating the user 122, so the data security system 100 may be accessed through the clear data channel 206 (e.g., internal bus).

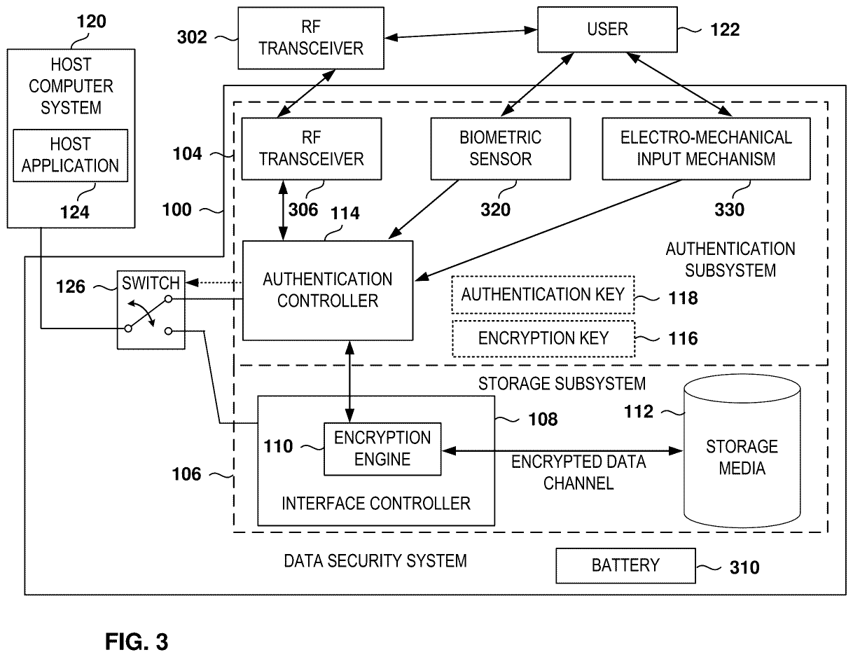

FIG. 3 is an illustration of different systems that allow the user to interact with the DSS 100. Some storage devices received authentication information from the host device. One of the downsides of this approach is the dependency on the host's OS. Any updates to the host OS often force to make updates to the internal firmware of the secure devices and updates to the software application running on the host to allow users to continue using secure devices with the updated host OS. Such dependency often creates costly and time-consuming problems with support, causing users in the field to be unable to unlock their secure devices and have access to their personal or corporate confidential information stored on the secure devices.

Because these authentication methods rely on the host, these secure devices have dependencies on the architecture of the host, such as hardware interfaces and host operating systems (OS). Further, by maintaining a communication channel to receive the passwords, such secure devices are susceptible to hacking via this communication channel and often cannot be completely locked out from the host as they (secure data storage devices) have to have some open data channels to send the user-authentication information.

Different companies have different security requirements based on their use and the environment. For example, some operational environments don't allow the use of wireless devices, like smartphones, inside certain areas.

There is a need for improved security to allow secure device configuration (e.g., device provisioning) and secure device operation (e.g., host OS independent). The presented techniques provide simple and easy-to-use methods of secure device configuration and secure device operation to enable users to unlock their secure devices using the method or methods that are most suitable for the specific environment.

The DSS 100 comprises an authentication subsystem 104, a storage subsystem 106, and a switch 126. The authentication controller 114 manages user authentication by verifying a user 122 against the authentication key 118. The authentication controller 114 is connected to an RF transceiver 306, which enables wireless communication with an external RF transceiver 302, allowing for user authentication via wireless communication, such as authentication via a mobile device using Bluetooth.

The authentication subsystem 104 also includes a biometric sensor 320 and an electro-mechanical input mechanism 330. The biometric sensor 320 allows for user authentication through biometric data, such as fingerprints or iris scans. The electro-mechanical input mechanism 330 provides an alternative method for user authentication by allowing the user to input a specific code, such as a PIN on a keypad in the DSS 100.

Once the user is authenticated, the authentication controller 114 transmits the encryption key 116 to the storage subsystem 106. The storage subsystem 106 contains the interface controller 108 and the encryption engine 110.

The switch 126, controlled by the authentication controller 114, is used to toggle the connection between the host computer system 120 and either the authentication controller 114 or the interface controller 108. This switch ensures that only one subsystem is accessible to the host at any given time, enhancing the security of the data by preventing unauthorized access.

In some examples, the DSS 100 is powered by a battery 310, which provides an internal power source, allowing the system to operate independently of the host computer system 120. This configuration supports multiple authentication methods, including wireless, biometric, electro-mechanical input, and host application 124, providing flexibility and adaptability to various user environments and security requirements.

In some examples, there are two modes of operation of the state of the drive. One mode is drive provisioning or configuration, where the administrator initializes the drive, e.g., set up user PIN or administrator PIN, timeout to lock the drive, etc. The second mode is to use the drive by a user, where the user enters authentication information to enable the drive for access to the memory in the drive via the external channel.

In some examples, the host 120 is able to communicate with the authentication controller to unlock the drive. While the drive is locked, the host can communicate with the authentication controller but may not be able to access the storage media in the DSS.

In one method for wireless authentication, the RF transceiver 302 (e.g., in a mobile phone, tablet, PC, key-fob, etc.) is employed to transmit user identification to the authentication controller 114 in the DSS 100. For exemplary purposes, transceivers are employed for bi-directional communication flexibility, but a transmitter-receiver combination for uni-directional communication could also be used.

The authentication subsystem 104 includes the authentication controller 114, which is connected to the interface controller 108 in the storage subsystem 106. The user identification is supplied to the DSS RF transceiver 306 within the authentication subsystem 104 by the RF transceiver 302. The wireless communication may include Wireless Fidelity (WiFi), Bluetooth (BT), Bluetooth Smart, Near Field Communication (NFC), Global Positioning System (GPS), optical, cellular communication (for example, Long-Term Evolution (LTE), Long-Term Evolution Advanced (LTE-A)), Code Division Multiple Access (CDMA), Wideband Code Division Multiple Access (WCDMA), Universal Mobile Telecommunications System (UMTS), Wireless Broadband (WiBro), or Global System for Mobile Communications (GSM), and the like.

The authentication subsystem 104 validates the user 122 against the authentication key 118 by a code sent from the RF transceiver 302 being validated against the authentication key 118. After a successful user authentication validation, the authentication subsystem 104 then transmits the encryption key 116 to the interface controller 108.

The authentication key 118 is kept in the authentication subsystem. Therefore, the user-authentication information is never accessible from the outside of the DSS 100 via the external communication channel or any other communication channel.

The encryption engine 110 then employs the encryption key 116 to convert clear information to encrypted information and encrypted information to clear information along the external data channel. Any attempt to read encrypted information from the storage media 112 without the encryption key 116 will result in information that is unusable by the host computer system 120.

In an optional second authentication mechanism, the authentication subsystem 104 validates the user 122 against the authentication key 118 by having the user 122 employ a biometric sensor 320 to supply a biometric input to verify the user's identity as an authorized user. Types of biometric identification include a fingerprint, an iris scan, a voice imprint, etc.

In an optional third authentication mechanism, the authentication subsystem 104 validates the user 122 against the authentication key 118 by having the user 122 employ an electro-mechanical input mechanism 330 to supply a unique code to verify the user's identity as an authorized user. The unique code can include a numerical, alphanumeric, or alphabetic code, such as a PIN. The electro-mechanical input mechanism 330 is within the authentication subsystem 104. The electro-mechanical input mechanism 330 receives the unique code from the user 122.

No matter which method is used to validate the user 122, the authentication key 118 and the encryption key 116 remain hidden in the authentication subsystem 104 until the user 122 is authenticated, and the interface controller 108 does not have access to the authentication key 118 or the encryption key 116. In some examples, the security controller may not even have power until the user has been authenticated.

In some examples, the data security system 100 includes an internal power source, such as a battery 310. In other examples, the data security system 100 does not include an internal power source and uses the power source provided by the host computer system 120. In other examples, the data security system 100 may use both a power source provided by the host and the internal power source.

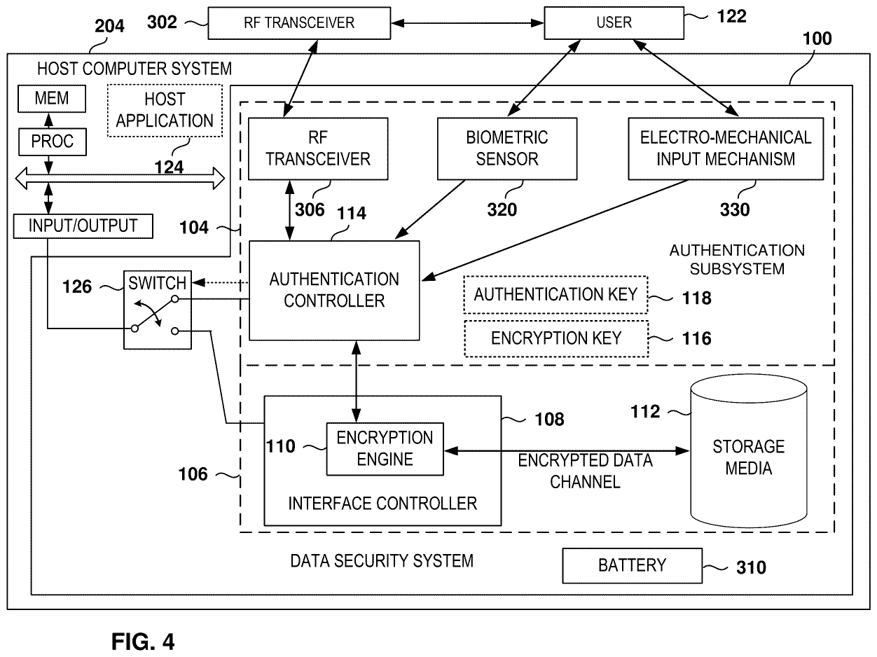

FIG. 4 illustrates the interaction of a mobile device with a host computer system 204 having an SED. The DSS 100 is installed inside the host computer system 204 and acts as an SED. The DSS 100 includes the same elements as described above with reference to FIG. 4, except that the communication channel is coupled to an input/output module connected to the bus within the host computer system 204. The host application 124 may communicate with the DSS 100 via the input/output module coupled to the switch 126.

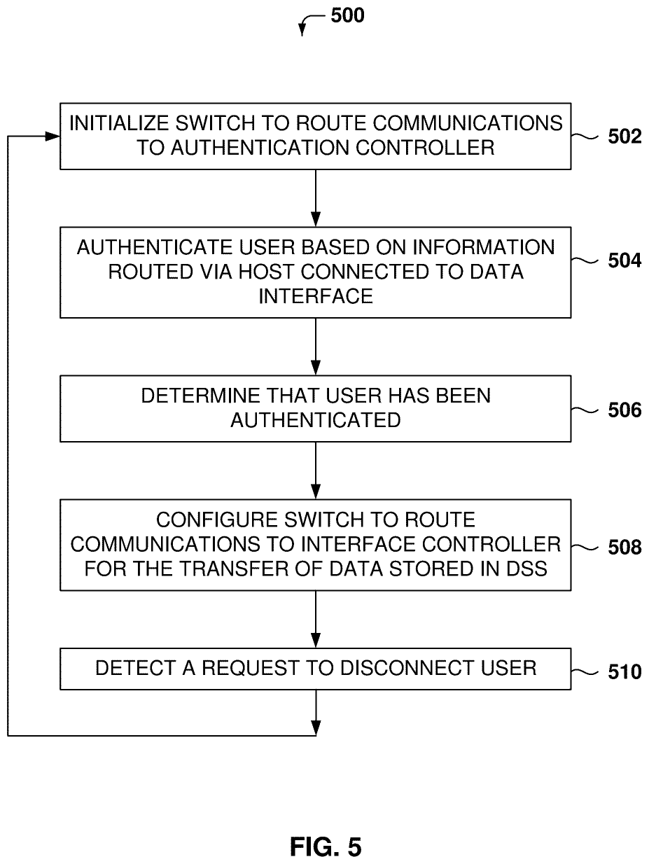

FIG. 5 is a flowchart of a method 500 for user authentication, according to some examples. While the various operations in this flowchart are presented and described sequentially, one of ordinary skill will appreciate that some or all of the operations may be executed in a different order, be combined or omitted, or be executed in parallel.

At operation 502, the authentication controller initializes the switch to route communications to the authentication controller itself. That is, the switch is configured to enable communications from the host application to the authentication controller to receive authentication information from the host.

From operation 502, the method 500 flows to operation 504, where the authentication controller authenticates the user based on information routed from the host connected to the data interface of the DSS. In other examples, the authentication via the host application may be combined with other authentication methods for dual authentication. Thus, authentication from the host app is one of the mechanisms required to validate the user. For example, the user may also have to enter a valid PIN on the keypad to enable the authentication.

From operation 504, the method 500 flows to operation 506, where a determination is made that the user has been authenticated based on the authentication information provided via the host. In some examples, the host application communicates with a management server, and the management server validates the user information (e.g., username and password) to perform the validation.

After the user is authenticated, at operation 508, the authentication controller configures the switch to route communications to the interface controller for the transfer of data stored in the DSS. At this point, the DSS behaves as a standard storage device operating to send and receive data.

From operation 508, the method 500 flows to operation 510, where a request to disconnect the user is received by the authentication controller. The request to disconnect the DSS may be received from an application executing on a mobile device that communicates via the RF transceiver. It is noted that the host application will not be able to process the request since the host application cannot communicate with the authentication controller after the switch is configured for data transfer.

Once the request is received, the authentication controller will initialize the switch again to route communications back to the authentication controller, as shown in operation 502.

Additionally, if the DSS is disconnected from the host, then the switch is reset to communicate with the authentication controller, and data transfer will not be possible until the user is re-authenticated. Another method includes pressing a key on the keypad of the DSS for a predetermined amount of time (e.g., three seconds) that will cause the locking of the DSS.

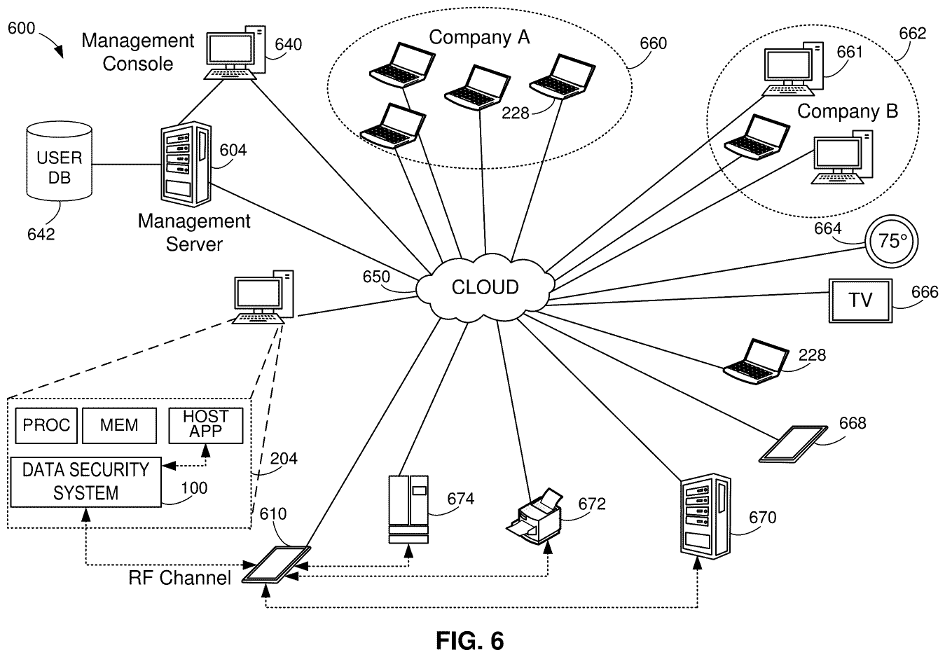

FIG. 6 illustrates a management architecture 600 for remote management of devices with encryption capabilities. The architecture includes a management server 604, which is connected to a user database 642. The management server 604 provides remote management, including remote security, of devices via a network, such as a cloud 650. A management console 640 may connect to the management server 604 directly or via the cloud 650. The management server 604 may be distributed across one or more servers that cooperate to provide the required management capabilities.

The management console 640 is used to access several user interfaces for configuring remote management, such as interfaces for managing accounts, users, drives, and enforcing information technology policies. The user database 642 stores information regarding users and devices.

The management server 604 manages a plurality of devices, such as laptops 228, PCs 661, thermostats 664, smart TVs 666, tablets 668, servers 670, printers and scanners 672, smart appliances 674, and mobile devices 610. Some devices may belong to the same company, such as the laptops of Company A 660 or the devices for Company B 662.

The management server 604 controls access to the DSS 100, which is connected to the host computer 120. The host application in the host computer 120 may communicate with the management server 604 to authenticate a user. That is, the user may enter authentication credentials (e.g., username and password), and the management server 604 validates the user. Once the user is validated, the host application may communicate with the DSS 100 to enable data transfer.

The cloud 650 facilitates communication between the management server 604 and various devices, enabling remote management and control. The architecture supports different types of services, such as secure-access control systems, home automation and security systems, healthcare and medical devices, and external and internal data storage devices.

The management console 640 may be used to access several user interfaces for configuring remote management, such as interfaces for managing accounts, users, drives, enforcing IT policies, etc. The user database 642 stores information regarding users and devices.

The management server 604 may manage a plurality of devices, such as laptops 228, PCs 661, thermostats 664, smart TVs 666, tablets 668, servers 670, printers and scanners 672, smart appliances 674, mobile devices 610, and other devices, such as residence doors, elevator doors, garage doors, hotel doors, office room doors, water supply valves, meters, medical devices, medicine cabinets, safes, home and corporate security and access control systems, home automation devices, smart speakers, voice-mail systems, etc. Some devices may belong to the same company, such as the laptops of Company A 660 or the devices for Company B 662.

For example, the management server 604 may control the access to the DSS 100, as described above. Further, the management server 604 may control different types of motors that can open or close a door or a safe, provide controlled access to video security cameras and their recorded video, etc.

Remote management may be used for different types of services, such as secure-access control systems, home automation and security systems, healthcare and medical devices, external and internal data storage devices, etc. The management server 604 communicates with the mobile device 706 to control the use of the DSS 100 inside the host computer 120.

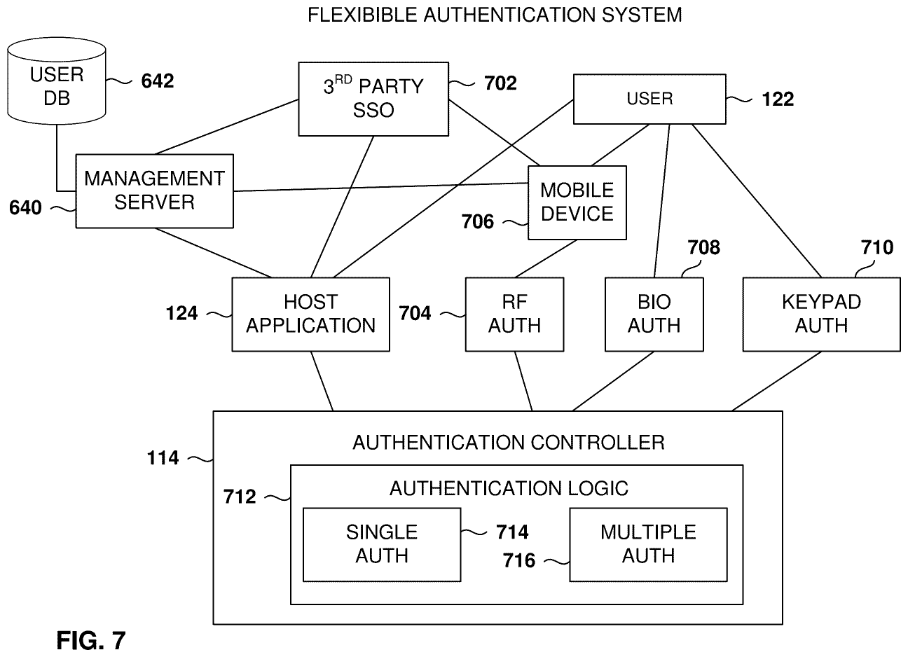

FIG. 7 illustrates the versatility of the DSS for authenticating a user before access is granted, according to some examples. The system integrates various components to provide a versatile authentication framework.

A user 122 interacts with the system through multiple authentication methods. In some examples, a user may be authenticated using any one of the authentication methods available. In other examples, the user is authenticated by combining two or more authentication methods. For example, a user may be required to enter a PIN on the keypad associated with the user and then use the host application 124 as a double-authentication mechanism.

The user can authenticate via a mobile device 706, which communicates with the authentication controller 114. The mobile device 706 can send RF authentication information 704 to the RF transceiver in the DSS to authenticate the user.

Further, bio authentication 708 and keypad authentication 710 may be used on the DSS itself to verify the user's credentials. Another authentication mechanism includes sending that authentication information from the host application 124 to the authentication controller 114.

Each of these methods provides a different mechanism for user verification, enhancing the system's adaptability to various user environments and security requirements.

The authentication controller 114 includes authentication logic 712, which determines whether single authentication 714 or multiple authentication 716 is required. This logic allows the system to adapt to different security policies and user preferences, providing either a single or multi-factor authentication process.

The host application 124 can also interact with the management server 604, which oversees the overall management of the authentication process. The management server 604 accesses the user database 642 to retrieve user credentials and authentication data, ensuring that only authorized users can access the system.

In some examples, a third-party Single Sign-On (SSO 702) is integrated into the system, allowing users to authenticate using existing credentials from external services. This integration simplifies the authentication process for users who already have established identities with third-party services. For example, if the DSS is connected to the host, the host application 124 may use SSO 702 to validate the user without requiring user intervention if the user is already logged in to an enabled account.

The system's architecture supports a flexible and secure authentication process, accommodating various user needs and security requirements. By incorporating multiple authentication methods and integrating with external services, the system provides a robust solution for secure user authentication.

In some examples, the host application includes a User Interface (UI) where the user can enter credentials, e.g., username and password. These credentials may be authenticated by the management console 640.

In other examples, the host application 124 is managed by the management console 640 without user intervention; that is, the host application may be executed as a service. When the DSS is connected to the host, the host application 124 will check the credentials of the user by accessing the management server 604. For example, the management server 604 may validate that the host where the host application is executing is authorized for communications with the DSS. This scenario is useful when a computing device is used at a place of work, and the management server 604 validates the devices that are executing in this location. This way, if a user connects the DSS to a home computer, the home computer will not be able to access the data stored in the DSS.

Further, the host application 124 may be used to configure the DSS, e.g., setting up a new user password or PIN. Since the host application 124 communicates directly with the authentication controller 114, after proper validation as an administrator, the host application may send commands to the authentication controller 114 to configure any aspect of the DSS. In some examples, after the user is authenticated, the DSS will show as a drive in the host device.

In some examples, the host application 124 is designed to operate as a service on a computer. This service is specifically intended for use on a computer where a USB drive is connected. For instance, if a user wishes to access the drive on a personal computer at home but not on a work computer, access will be denied if the personal computer does not have the host application configured as a service. Additionally, this setup enables corporate IT administrative personnel to manage authorizations, ensuring not only that the employee remains a valid authorized user permitted to unlock the drive but also dictating which computers can be utilized for unlocking it.

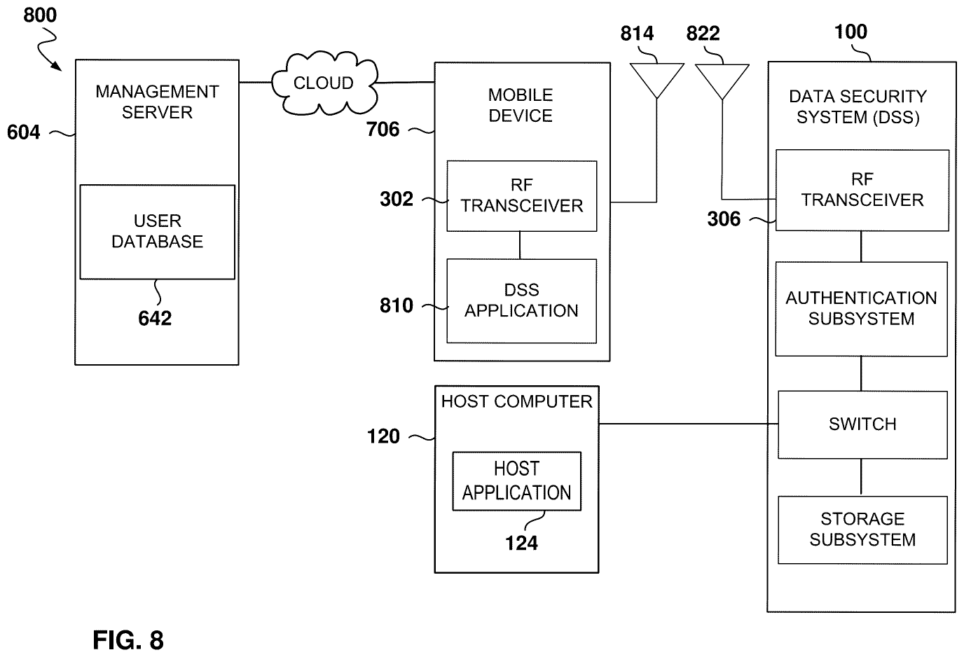

FIG. 8 is an exemplary data security communication system 800. The exemplary data security communication system 800 includes a mobile device 706, the DSS 100, a host computer 120, and a management server 604. The mobile device 706 and the management server 604 are connected by wired or wireless connections through a cloud 650, which can be an Internet cloud. In some examples, the mobile device 706 and the DSS 100 are connected via RF communication.

The communication is between RF transceiver 302 in the mobile device 706 with an antenna 814 and RF transceiver 306 with an antenna 822 of the DSS 100.

The RF transceiver 306 is connected to the authentication subsystem, which can contain identification, passwords, profiles, or information, including that of different mobile devices that can access the DSS 100. The switch in the DSS 100 is connectable to the host computer system 120.

One implementation of the DSS 100 can eliminate the biometric sensor and the electro-mechanical input mechanism of FIG. 3 with only a wireless link to the mobile device 706.

The data security system application 810 allows the mobile device 706 to discover data security systems in the vicinity of the mobile device 706 and show their status (locked/unlocked/blank, paired/unpaired, etc.). Further, the data security system application 810 allows the mobile device 706 to connect/pair, lock, unlock, change the name and password, and reset data on the DSS 100. Similarly, the host application 124 allows the user to connect/pair, lock, unlock, change the name and password, and reset data on the DSS 100.

The data security system application 810 and the host application 124 allow the administrator to set an inactivity auto-lock so the DSS 100 will automatically lock after a predetermined period of inactivity or to set a proximity auto-lock so the DSS 100 will be locked when the mobile device 706 is not within a predetermined proximity for a predetermined time period (to improve reliability and avoid signal de-bouncing).

The data security system application 810 and the host application 124 allow the mobile device 706 to be set to operate only with a specific mobile device, such as the mobile device 706, so the DSS 100 cannot be unlocked with other mobile devices (e.g., iPhone).

The data security system application 810 and the host application 124 allow the administrator to set the DSS 100 to Read-Only.

The data security system application 810 and the host application 124 allow the administrator to operate in User Mode or Administrator Mode (administrator's mode overrides user's settings) and use the management server 604.

The management server 604 contains a user database 642, which contains additional information that can be transmitted over the cloud 650 to the mobile device 706 and the host application 124 to provide additional functionality.

The user database 642 allows the management server 604 to create and identify users using user identification information (e.g., username and password), to lock or unlock the DSS 100, and to provide remote help. Further, the user database 642 allows the management server 604 to reset or unlock the DSS 100 remotely.

The user database 642 allows the management server 604 to change the data security system user's PIN remotely. Also, the user database 642 allows the management server 604 to restrict/allow unlocking DSS 100 from specific locations (e.g., by using geo-fencing). The user database 642 allows the management server 604 to restrict/allow unlocking DSS 100 in specified time periods and different time zones. Further, the user database 642 allows the management server 604 to restrict unlocking DSS 100 outside of specified teams/organizations/networks, etc.

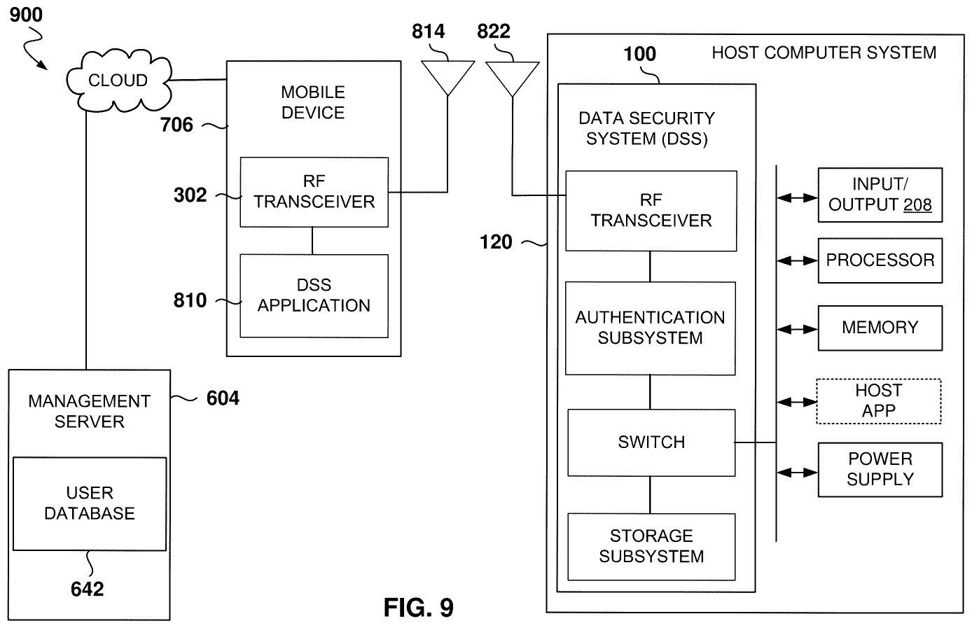

FIG. 9 is another data security communication system 900 with an embedded DSS 100 (also referred to herein as a SED), according to some examples.

The host computer system 120 includes the DSS 100, which includes the RF transceiver, authentication subsystem, storage subsystem, and switch, as described above with reference to FIG. 2. Additionally, the host computer system 120 includes the host app executable on the processor of the host computer system 120.

As described above with reference to FIG. 2, the RF transceiver 306 may be used to authenticate the DSS 100, as well as the host application on the host (not shown).

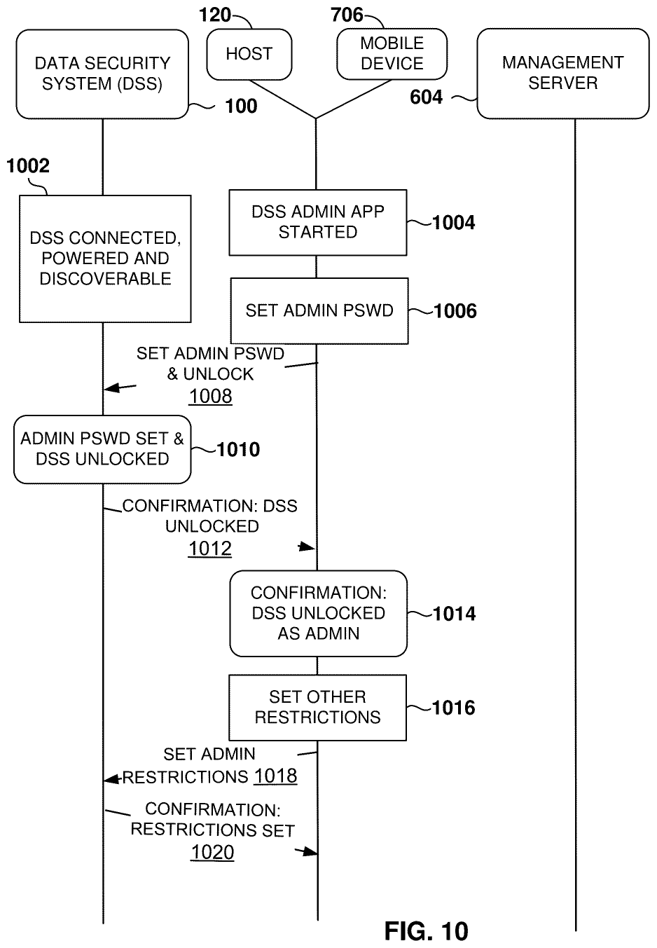

FIG. 10 is an administrator sequencing diagram showing the sequence of operations between a device and the DSS, according to some examples.

The connectivity between the DSS 100 and the mobile device 706, or the host computer system 120, is established with the mutual discovery of the other device or system, pairing the device and system, and connection of the device and system. The connectivity is secured using a shared secret, which is then used to secure (encrypt) communications between the DSS 100 and the mobile device 706 or the host computer system 120 for future communication sessions. A standard encryption algorithm is selected to be both efficient to run on the DSS 100 and to be approved by worldwide security standards.

Initially, the host computer system 120 is connected, powered, and discoverable 1002, establishing connectivity with the host 120 or the mobile device 706. After connection of the mobile device 706 or the host computer system 120 and the DSS 100, a data security system administrator application start operation 1004 occurs in the mobile device 706 or the host computer system 120. Then, the administrator sets a password in an administrator password operation 1006.

After setting the administrator password, the mobile device 706 or the host computer system 120 sends a set administrator password and unlock signal 1008 to the DSS 100. The set administrator password and unlock signal 1008 causes an administrator password set and data security system unlocked operation 1010 to occur in the DSS 100.

When the administrator password is set and the data security system unlocked operation 1010 is completed, a confirmation data security system unlocked signal 1012 is sent to the mobile device 706 or the host computer system 120.

The confirmation: data security system unlocked as administrator operation 1014 permits a set-other-restrictions operation 1016 to be performed using the mobile device 706 or the host computer system 120. The set other restrictions operation 1016 causes a set administrator restrictions signal 1018 to be sent to the DSS 100 where the administrator restrictions are set and a confirmation: restrictions set signal 1020 is returned to the mobile device 706 or the host computer system 120. Thereafter, the mobile device 706 or the host computer system 120 and the DSS 100 are in full operative communication.

The DSS 100 can be used in a user mode, where the functionalities of the DSS 100 are determined by the user, and an administrator mode, where an administrator can set an administrator password and enforce some restrictions on the DSS 100.

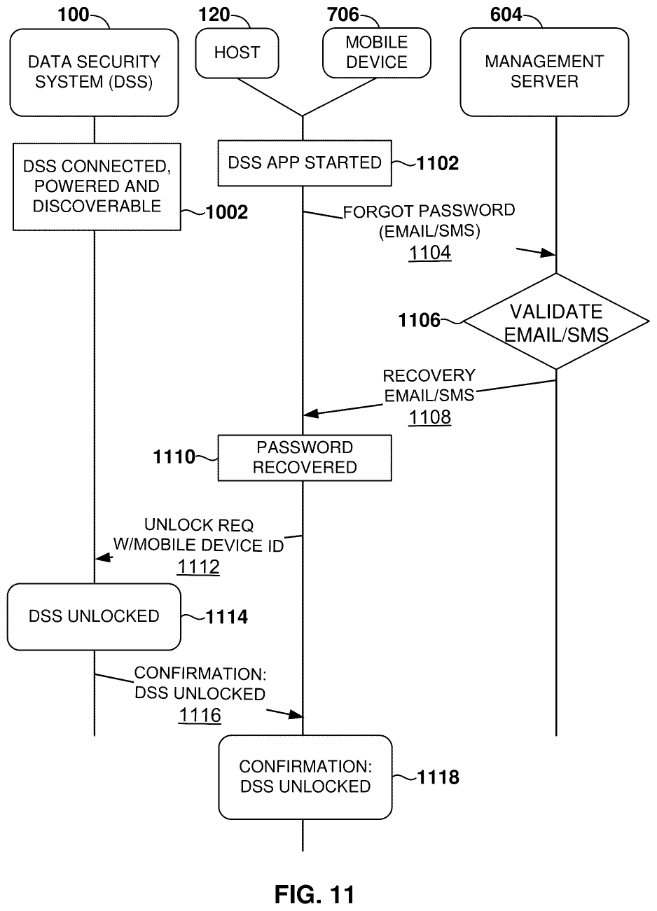

FIG. 11 is an unlocking-sequence diagram using an external device as an authentication factor. The mobile device 706 or the host computer system 120 is used as an authentication factor. This diagram shows an auto-unlock process, of the DSS 100, initiated by the data security system application 810 from the mobile device 706 or the host computer system 120.

The data security system application started operation 1102 occurs after the connectivity is established. A forgot password 1104 request is sent to the management server 604 from the mobile device 706 or the host computer system 120, indicating if the recovery is to be performed via email or SMS message.

At operation 1106, the management server 604 performs the operation to recover or reset the password using email or SMS to a mobile phone. After the validation, the management server 604 sends a recovery confirmation message 1108 to the mobile device 706 or the host computer system 120. At operation 1110, the mobile device 706 or the host computer system 120 detects that the password has been recovered

An unlock required with mobile device ID signal 1112 is sent from the mobile device 706 or the host computer system 120 to the DSS 100 after a data security system is connected, powered, and discoverable operation. A DSS unlocked operation 1114 occurs, and a confirmation: data security system unlocked signal 1116 is sent from the DSS 100. After confirmation, a data security system unlocked operation 1118, the mobile device 706 and/or the host computer system 120 and the DSS 100 are in full operative communication.

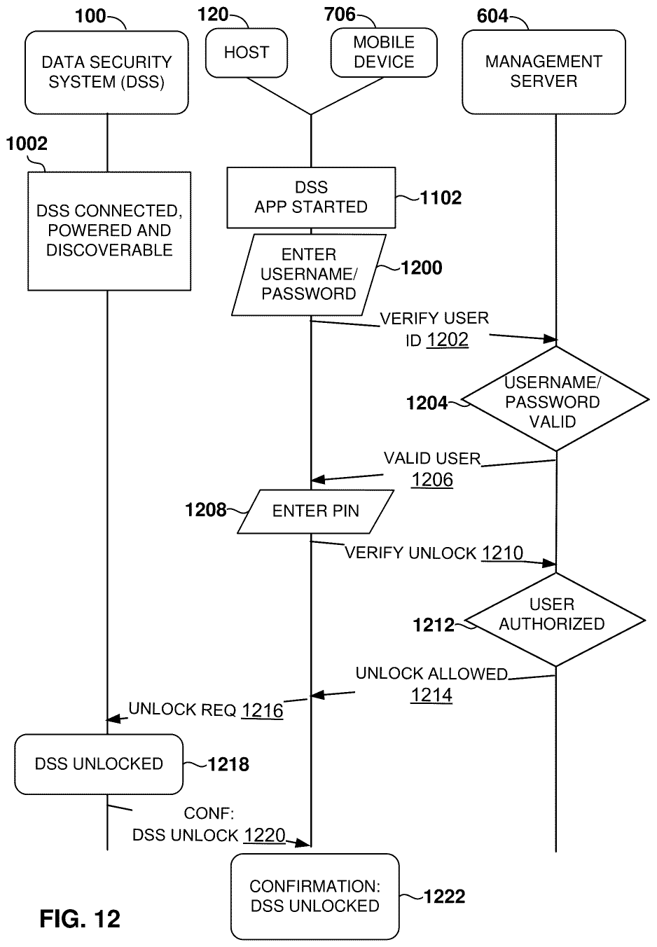

FIG. 12 is an unlocking-sequence diagram showing unlocking using a PIN entry from the external device. This diagram shows the process of unlocking the DSS 100 by entering a PIN in the data security system application 810 in the mobile device 706 or the host computer system 120. The DSS 100 cannot be unlocked without entering the correct PIN.

An enter username/password operation 1200 occurs after the data security system application is started at operation 1102. After operation 1200, the mobile device 706 or the host computer system 120 sends a verify user ID signal 1202 to the management server 604. The management server 604 then makes a username/password valid determination 1204.

When the username/password valid determination 1204 verifies the user, a valid user signal 1206 is sent to the mobile device 706 or the host computer system 120 for the user to enter the correct PIN in operation 1208 in the mobile device 706 or the host computer system 120. The mobile device 706 or the host computer system 120 then sends a verify unlock signal 1210 to determine if the correct PIN has been entered to the management server 604.

The management server 604 makes a user authorized determination 1212 and determines if the user is authorized to use the specific data security system that the PIN is authorized for. If authorized, an unlock allowed signal 1214 is sent to the mobile device 706 or the host computer system 120, which passes on an unlock request signal 1216 to the DSS 100.

The data security system unlocked operation 1218 is performed and the confirmation: data security system unlocked signal 1220 is sent to the mobile device 706 or the host computer system 120. At operation 1222, that DSS 100 is unlocked.

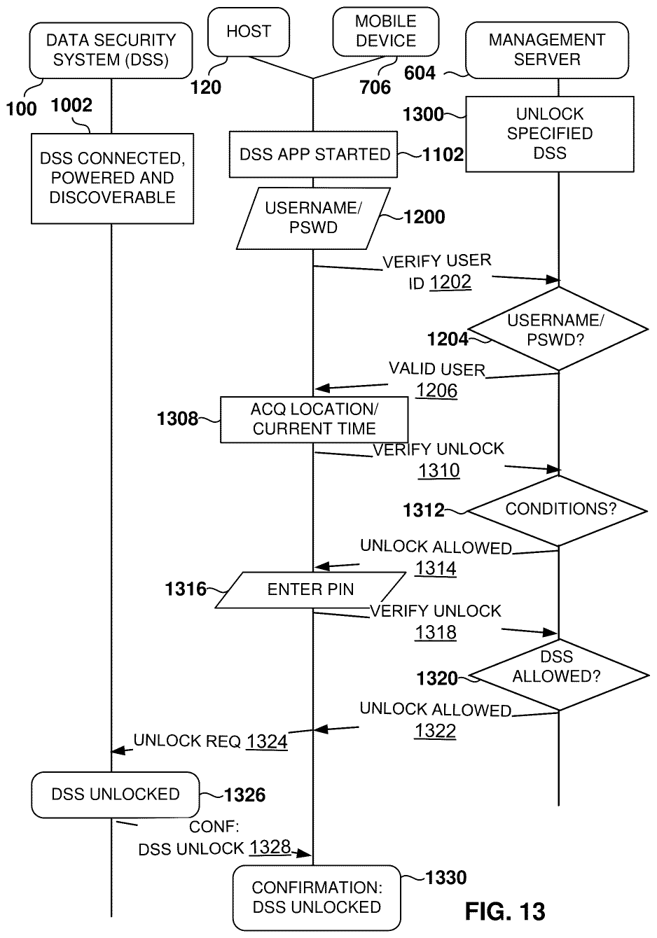

FIG. 13 is an unlocking-sequence diagram showing unlock using a PIN entry and user ID/location/time verification via the management server 604, according to some examples.

Similar to FIGS. 10-12, an unlock specified data security system operation 1300 is performed to allow the setting of the desired conditions under which the specified data security system, such as the DSS 100, will operate. For example, the conditions could be within a specific geographical area and/or specific time frame.

At the mobile device 706 or the host computer system 120, a current condition determination is made, such as in an acquire location and/or current time operation 1308. This operation is performed to determine where the mobile device 706 or the host computer system 120 is located and or what the current time is where the mobile device 706 or the host computer system 120 is located. Other current conditions around the mobile device 706 or the host computer system 120 may also be determined and sent by a verify unlock signal 1310 to the management server 604 where a conditions-met determination 1312 is made.

When the desired conditions are met, an unlock allowed signal 1314 is sent to the mobile device 706 or the host computer system 120 for the enter PIN operation 1316 to be performed. After the PIN is entered, a verify unlock signal 1318 is sent with the PIN and an identification of the DSS 100. The verify unlock signal 1318 is received by the management server 604 and a data security system allowed determination 1320 is made to determine that the specified data security system is allowed to be unlocked by the authorized user. The management server 604 verifies that this “specific” user is authorized to use the specified data security system.

After determining the correct information has been provided, the management server 604 will provide an unlock-allowed signal 1322 to the mobile device 706 or the host computer system 120, which will provide an unlock request signal 1324. The DSS is unlocked at operation 1326, and a confirmation 1328 DSS unlocked is sent to the host 120 or the mobile device 706, which will confirm that the DSS is unlocked at operation 1330.

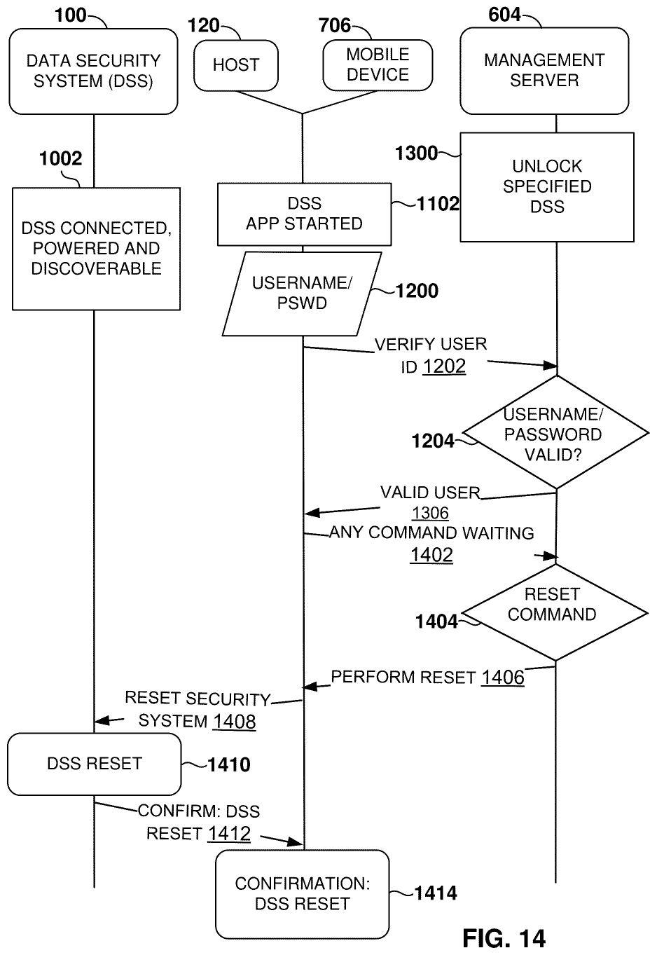

FIG. 14 is a reset sequencing diagram showing resetting the DSS using the management server 604. This diagram shows the ability to reset the DSS 100 remotely via the management server 604. The DSS 100 can receive commands from the mobile device 706 or the host computer system 120. However, by setting a “Reset” flag on the management server 604 for a specific data security system (using its S/N), the data security system application running on the mobile device 706 or the host computer system 120 will query the management server 604 for any flags/pending requests in the user database 642. When the user connects the DSS 100, the data security system application 810 on the mobile device 706 or the host computer system 120 will execute a waiting “reset” command. After a successful reset (e.g., all user data and credentials are erased and unrecoverable), the management server 604 will remove the reset flag so it will not be executed the next time the mobile device 706 or the host computer system 120 is connected to the specific DSS.

Similarly to FIGS. 10-13, the mobile device 706 or the host computer system 120 responds to the valid user signal 1206 by sending any command waiting signal 1402 to the management server 604 to make a reset command determination 1404. When the reset command is present, a perform reset signal 1406 is sent to the mobile device 706 or the host computer system 120.

The mobile device 706 or the host computer system 120 will send a reset security system signal 1408 to the DSS 100 to start a data security system reset operation 1410. Upon completion of the data security system reset operation 1410, the DSS 100 will send a confirmation: data security system reset signal 1412 to the mobile device 706 or the host computer system 120 to set a confirmation: data security system reset operation 1414.

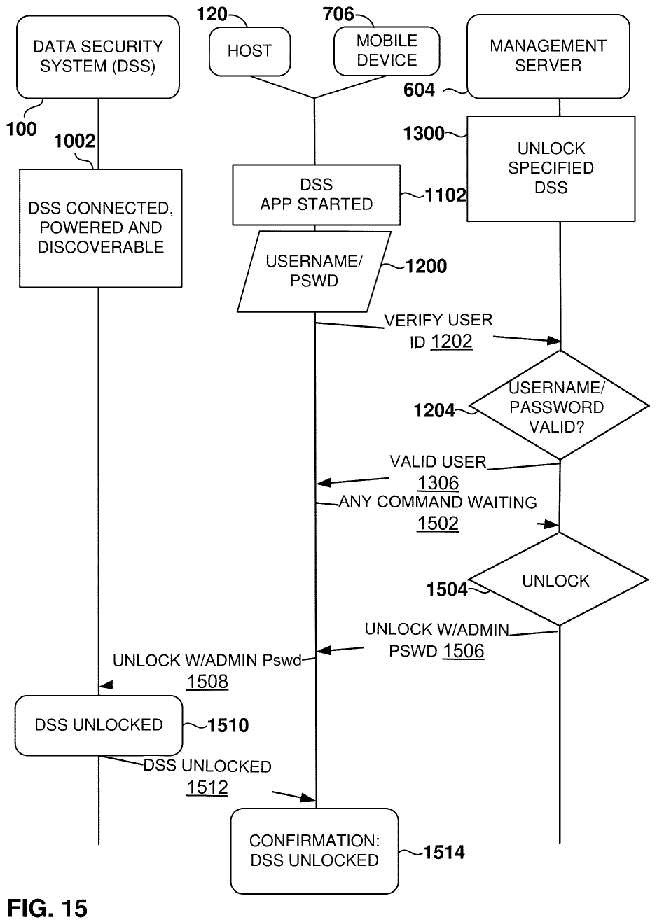

FIG. 15 is an unlocking-sequence diagram showing the unlocking of the data security system using the management server 604. This diagram shows the ability to unlock the DSS 100 remotely via the management server 604. This example shows the processing of a waiting “unlock” command, but the same principle of operation may be used for other pending commands, census, but it could be any pending command such as lock, reset, change password, update user pin, update recovery pin, etc.

The DSS 100 can receive commands from the mobile device 706 or the host computer system 120 over the wireless connection or the data channel. However, by setting an “Administrator Unlock” flag on the management server 604 for a specific data security system (e.g., using its S/N), the data security system application 810 running on the mobile device 706 or the host computer system 120 will query the management server 604 for any flags indicating pending requests at operation 1502.

The management server 604 checks if there is an unlock command waiting at operation 1504. Upon determining that there is an unlock command pending, the management server 604 will send an unlock with admin password request 1506.

The host computer system 120 or the mobile device 706 will send a request 1508 to the DSS 100 to unlock with the administrator password, and the DSS 100 will unlock operation 1510.

After successful Administrator unlock, the user's data is untouched, but the user's password is removed (the DSS 100 cannot be unlocked by the user). The management server 604 will reset the Reset flag for the DSS 100, so it will not be executed the next time the mobile device 706 or the host computer system 120 is connected to the DSS 100. At operation 1514, the confirmation of the DSS unlocked is received.

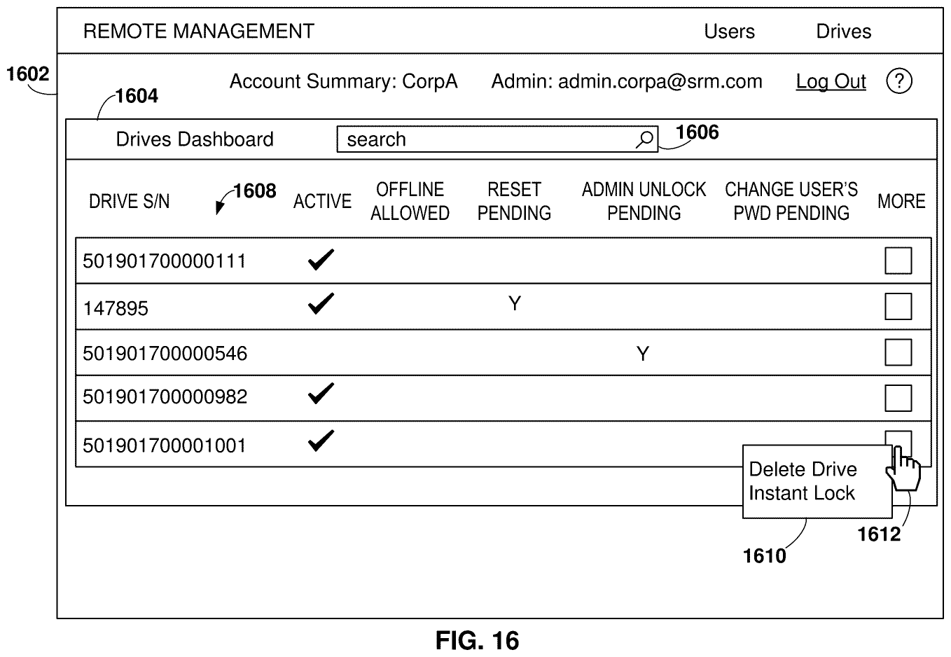

FIG. 16 is a user interface 1602 for configuring drive operations, according to some examples. The remote management user interface provides different options for managing users, administrators, counts, drives, licenses, etc. The user interface 1602 includes a message indicating that this screen corresponds to an account summary for a company (e.g., CorpA) for a given administrator of the company (e.g., admin.corpa@srm.com).

The drive information is presented in tabular form in a drive dashboard 1604, which includes drives table 1608 and a search option 1606 for searching drives. The drives table 1608 includes information for a list of drives, identified in the first column by their serial number. For each drive, the drives table 1608 indicates if the drive is active or not, a flag indicating if offline use is allowed, a flag indicating if a reset is pending for the drive, a flag indicating if an administrator unlock command is pending, a flag indicating if a change of user password is pending, and a more button 1612 that provides additional options. In some examples, the more button 1612 provides options for deleting a drive from the system and for instantly locking the drive (as soon as communication with the drive is established).

The options for managing drives allow flexibility in the control of SEDs. For example, if an administrator suspects that a drive is being attacked by a malicious agent, the administrator can set a command to delete the drive or instantly lock the drive 1610. Once communication is established with the drive (e.g., via the mobile device), a delete drive operation will destroy the encryption key in the drive, and since the data is stored encrypted, it will not be possible to access the data stored in the drive.

If the instant lock is set, the drive will automatically lock. For example, if a laptop is stolen, the instant lock will automatically lock the drive without having to wait for a timeout or detect that the mobile device is beyond the safe area of operation.

Additionally, the administrator may request a remote unlock of the drive, and when the indication is established with the drive, the drive will automatically unlock and enable the data channel.

If the administrator selects one of the drives, a new screen (not shown) will provide additional options for managing the drive, such as locking or unlocking the drive, resetting the drive, changing the user password, and ordering an administrator unlock, indicating the user associated with the drive.

In some examples, if the user selects one of the drives, a new UI will be presented with a map indicating the estimated location of the drive.

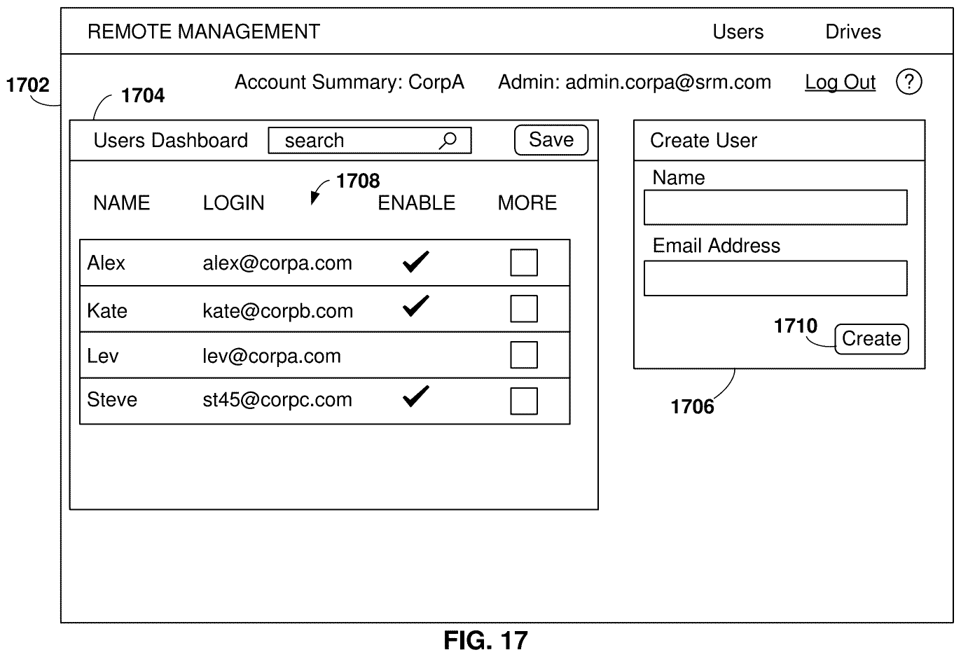

FIG. 17 is a user interface 1702 for managing users of remote devices, according to some examples. The user interface 1702 includes a user dashboard 1704 and a window 1706 for adding users.

The user dashboard 1704 presents the users of the system in a user table 1708. For each user, the user table 1708 provides the name of the user, the login, a flag indicating if the user is enabled or disabled, and a button that provides additional commands, such as delete user, rename user, change password, etc.

The window 1706 provides fields for entering the name of the new user, the email address of the new user, an option for importing data for the user, and a create-user button 1710.

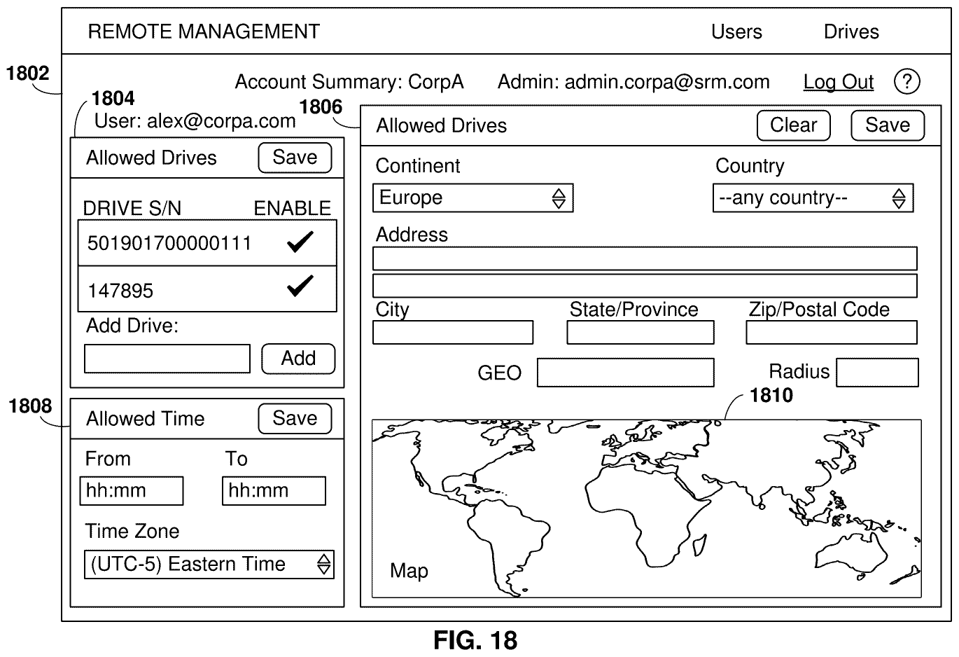

FIG. 18 is a user interface 1802 for setting time and geographic constraints on the use of devices. The user interface 1802 allows configuring options for a user (e.g., alex@corpa.com). A window 1804 lists the drives enabled for this user and provides a field for adding additional drives.

The windows 1808 and 1806 provide options for setting limits to the drives. The window 1808 includes two fields for entering a begin time and an end time in the day when the use is allowed. Another field allows the user to select the time zone for the time boundaries. If no time limits are set, the user may use the drive anytime during the day.

The window 1806 enables setting geographic limitations for the use of the allowed drives. The limitations may include setting an address (including street address, city, and country) or geographic coordinates that, together with a radius, define the region where the drive or drives may be used. The geographic limitations may also be configured for use in a given continent. A map 1810 highlights the areas where use is permitted or not permitted based on the geographic parameters configured.

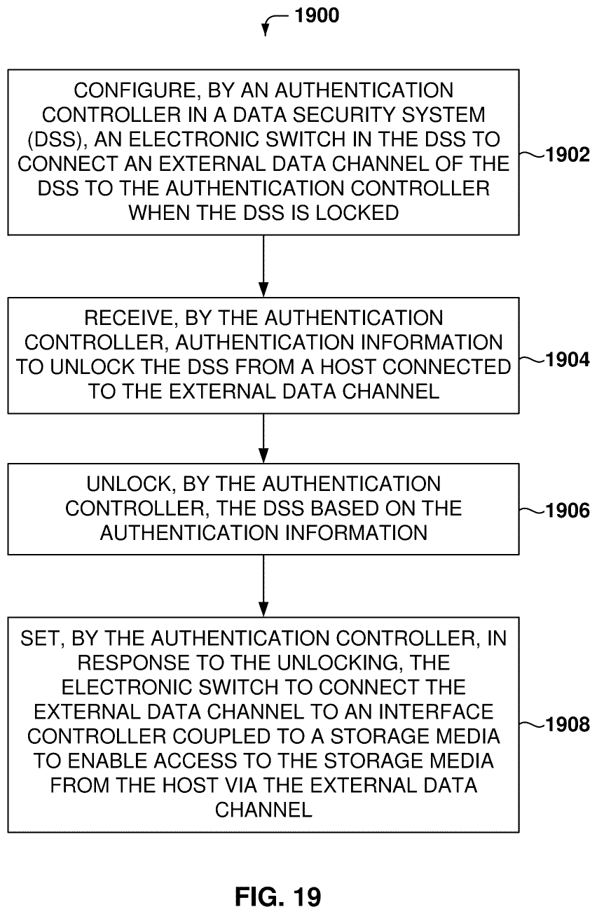

FIG. 19 is a flow chart of a method 1900 for authenticating the DSS, according to some examples. While the various operations in this flowchart are presented and described sequentially, one of ordinary skill will appreciate that some or all of the operations may be executed in a different order, be combined or omitted, or be executed in parallel.

At operation 1902, an authentication controller in a data security system (DSS) configures an electronic switch in the DSS to connect an external data channel of the DSS to the authentication controller when the DSS is locked

From operation 1902, the method 1900 flows to operation 1904, where the authentication controller receives authentication information to unlock the DSS from a host connected to the external data channel.

From operation 1904, the method 1900 flows to operation 1906, where the authentication controller unlocks the DSS based on the authentication information.

From operation 1906, the method 1900 flows to operation 1908, for setting, by the authentication controller, in response to the unlocking, the electronic switch to connect the external data channel to an interface controller coupled to a storage media to enable access to the storage media from the host via the external data channel.

Another general aspect is for a tangible machine-readable storage medium (e.g., a non-transitory storage medium) includes instructions that, when executed by a machine, cause the machine to perform operations comprising: configuring, by an authentication controller in a data security system (DSS), an electronic switch in the DSS to connect an external data channel of the DSS to the authentication controller when the DSS is locked; receiving, by the authentication controller, authentication information to unlock the DSS from a host connected to the external data channel; unlocking, by the authentication controller, the DSS based on the authentication information; and setting, by the authentication controller, in response to the unlocking, the electronic switch to connect the external data channel to an interface controller coupled to a storage media to enable access to the storage media from the host via the external data channel.

In view of the disclosure above, various examples are set forth below. It should be noted that one or more features of an example, taken in isolation or combination, should be considered within the disclosure of this application.

Example 1. A data security system (DSS) comprising: a storage media; an interface controller coupled to the storage media, the interface controller configured to enable access to the storage media when the DSS is unlocked; an authentication controller coupled to the interface controller, the authentication controller configured to authenticate a user to unlock the DSS; and an electronic switch controlled by the authentication controller, the electronic switch connecting an external data channel of the DSS to one of the authentication controller or the interface controller; wherein the authentication controller sets the electronic switch for communication to the authentication controller when the DSS is locked, wherein the authentication controller is configured to receive authentication information to unlock the DSS from a host via the external data channel, wherein the authentication controller sets the electronic switch for communication to the interface controller after the DSS is unlocked to enable access to the storage media from the host via the external data channel and the electronic switch.

Example 2. The DSS recited in Example 1, wherein the authentication controller is configured to receive authentication information via the external data channel when the DSS is locked.

Example 3. The DSS of any one or more of Examples 1-2, wherein the authentication information, received via the external data channel, comprises user identifier and a Personal Identification Number (PIN).

Example 4. The DSS of any one or more of Examples 1-3, wherein an application executing on the host includes options for authenticating the user, wherein the authentication controller communicates with the application via the external data channel.

Example 5. The DSS of any one or more of Examples 1-4, wherein the application is configured to communicate with the authentication controller to manage user and administrator credentials and DSS configuration parameters.

Example 6. The DSS of any one or more of Examples 1-5, wherein the application communicates with a server to authenticate a user based on information provided by the user, wherein the authentication controller is configured to receive authentication validation originated at the server after the server authenticates the user based on the information provided by the user in the application.

Example 7. The DSS of any one or more of Examples 1-6, wherein the application is configured to communicate with the authentication controller and the server to manage user and administrator credentials and DSS configuration parameters.

Example 8. The DSS of any one or more of Examples 1-7, wherein the DSS further comprises: a radiofrequency (RF) transceiver coupled to the authentication controller, wherein the authentication controller comprises logic for double authentication using information received from the host via the external data channel and information received via the RF transceiver.

Example 9. The DSS of any one or more of Examples 1-8, wherein the DSS further comprises: a biometric sensor coupled to the authentication controller, wherein the authentication controller comprises logic for double authentication using information received from the host via the external data channel and information received via the biometric sensor.

Example 10. The DSS of any one or more of Examples 1-9, wherein the DSS further comprises: an electro-mechanical input mechanism coupled to the authentication controller, wherein the authentication controller comprises logic for double authentication using information received from the host via the external data channel and information received via the electro-mechanical input mechanism.

Example 11. The DSS of any one or more of Examples 1-10, wherein the DSS further comprises: a radiofrequency (RF) transceiver coupled to the authentication controller; and an electro-mechanical input mechanism coupled to the authentication controller, wherein the authentication controller comprises logic for double authentication using information received from a mobile device via the RF transceiver and information received via the electro-mechanical input mechanism.

Example 12. The DSS of any one or more of Examples 1-11, wherein the authentication controller is configured to lock the DSS after receiving a request to lock the DSS via an RF transceiver, a biometric sensor, or an electro-mechanical input mechanism.

Example 13. The DSS of any one or more of Examples 1-12, wherein the authentication controller is configured to lock the DSS in response to the DSS being disconnected from the host.

Example 14. A method comprising: configuring, by an authentication controller in a data security system (DSS), an electronic switch in the DSS to connect an external data channel of the DSS to the authentication controller when the DSS is locked; receiving, by the authentication controller, authentication information to unlock the DSS from a host connected to the external data channel; unlocking, by the authentication controller, the DSS based on the authentication information; and setting, by the authentication controller, in response to the unlocking, the electronic switch to connect the external data channel to an interface controller coupled to a storage media to enable access to the storage media from the host via the external data channel.

Example 15. The method of Example 14, wherein the authentication controller is configured to receive the authentication information via the external data channel when the DSS is locked.

Example 16. The method of any one or more of Examples 14-15, wherein the authentication information, received via the external data channel, comprises a Personal Identification Number (PIN).

Example 17. The method of any one or more of Examples 14-16, wherein an application executing on the host includes options for authenticating a user, wherein the authentication controller communicates with the application via the external data channel.

Example 18. The method of any one or more of Examples 14-17, wherein the application communicates with a server to authenticate a user based on information provided by the user, wherein the authentication controller is configured to receive authentication validation originated at the server after the server authenticates the user based on the information provided by the user in the application.

Example 19. The method of any one or more of Examples 14-18, wherein the DSS further comprises a radiofrequency (RF) transceiver coupled to the authentication controller, wherein the authentication controller comprises logic for double authentication using information received from the host via the external data channel and information received via the RF transceiver.

Example 20. A machine-storage medium including instructions that, when executed by a machine, cause the machine to perform operations comprising: configuring, by an authentication controller in a data security system (DSS), an electronic switch in the DSS to connect an external data channel of the DSS to the authentication controller when the DSS is locked; receiving, by the authentication controller, authentication information to unlock the DSS from a host connected to the external data channel; unlocking, by the authentication controller, the DSS based on the authentication information; and setting, by the authentication controller, in response to the unlocking, the electronic switch to connect the external data channel to an interface controller coupled to a storage media to enable access to the storage media from the host via the external data channel.

Some of the concepts used for the description of the solution are presented below.

An authentication controller is a component configured to authenticate a user to unlock the Data Security System (DSS) by processing authentication information received via an external data channel or other channels.

A biometric sensor is a device coupled to the authentication controller that is used for double authentication by receiving biometric data from a user.

A storage media is a hardware component within the DSS that stores digital information in binary format (e.g., data, applications) and is accessible when the DSS is unlocked.

A Data Security System (DSS) is a system comprising, at least, a computer storage media, an interface controller, an authentication controller, and an electronic switch that is designed to provide secure data storage and access.

An electronic switch is a switch controlled by the authentication controller, connecting the external data channel of the DSS to either the authentication controller or the interface controller.

A host computer system is a computer device comprising a computer processor and a communications interface to connect to the DSS 100. The host computer system may also be referred to herein as host, host system, computer device, or device.

An external data channel is a communication pathway that connects a host to the DSS (e.g., a USB port), allowing the transmission of authentication information and data access commands.

An interface controller is a component coupled to the computer storage media, configured to enable access to the media when the DSS is unlocked.

A Personal Identification Number (PIN) is a code used as part of the authentication information to unlock the DSS.

A radiofrequency (RF) transceiver is a device coupled to the authentication controller that is used to receive information via radiofrequency communication.

Unlocking is the process performed by the authentication controller to enable access to the computer storage media in the DSS.

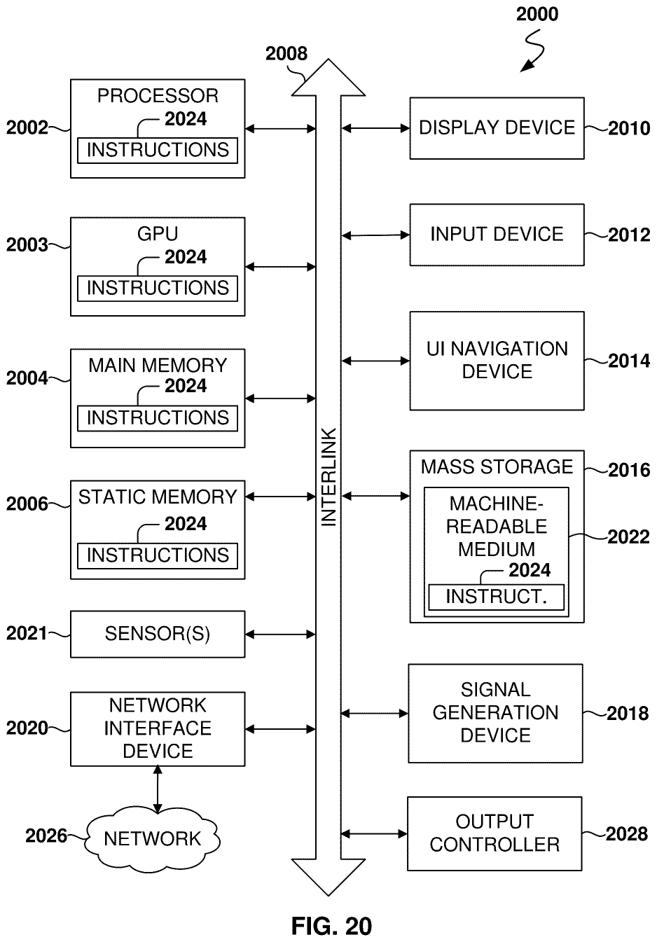

FIG. 20 is a block diagram illustrating an example of a machine 2000 upon or by which one or more process examples described herein may be implemented or controlled. In alternative examples, the machine 2000 may operate as a standalone device or be connected (e.g., networked) to other machines. In a networked deployment, the machine 2000 may operate in the capacity of a server machine, a client machine, or both in server-client network environments. In an example, the machine 2000 may act as a peer machine in a peer-to-peer (P2P) (or other distributed) network environment. Further, while only a single machine 2000 is illustrated, the term “machine” shall also be taken to include any collection of machines that individually or jointly execute a set (or multiple sets) of instructions to perform any one or more of the methodologies discussed herein, such as via cloud computing, software as a service (SaaS), or other computer cluster configurations.

Examples, as recited herein, may include, or may operate by, logic, various components, or mechanisms. Circuitry is a collection of circuits implemented in tangible entities, including hardware (e.g., simple circuits, gates, logic). Circuitry membership may be flexible over time and underlying hardware variability. Circuitries include members that may, alone or in combination, perform specified operations when operating. In an example, the hardware of the circuitry may be immutably designed to carry out a specific operation (e.g., hardwired). In an example, the hardware of the circuitry may include variably connected physical components (e.g., execution units, transistors, simple circuits), including a computer-readable medium physically modified (e.g., magnetically, electrically, by moveable placement of invariant massed particles) to encode instructions of the specific operation. In connecting the physical components, the underlying electrical properties of a hardware constituent are changed (for example, from an insulator to a conductor or vice versa). The instructions enable embedded hardware (e.g., the execution units or a loading mechanism) to create members of the circuitry in hardware via the variable connections to carry out portions of the specific operation when in operation. Accordingly, the computer-readable medium is communicatively coupled to the other circuitry components when the device operates. In an example, any of the physical components may be used in more than one member of more than one circuitry. For example, under operation, execution units may be used in a first circuit of a first circuitry at one point in time and reused by a second circuit in the first circuitry or by a third circuit in a second circuitry at a different time.

The machine 2000 (e.g., computer system) may include a hardware processor 2002 (e.g., a central processing unit (CPU), a hardware processor core, or any combination thereof), a graphics processing unit (GPU 2003), a main memory 2004, and a static memory 2006, some or all of which may communicate with each other via an interlink 2008 (e.g., bus). The machine 2000 may further include a display device 2010, an alphanumeric input device 2012 (e.g., a keyboard), and a user interface (UI) navigation device 2014 (e.g., a mouse). In an example, the display device 2010, the alphanumeric input device 2012, and the UI navigation device 2014 may be a touch screen display. The machine 2000 may additionally include a mass storage device 2016 (e.g., a drive unit), a signal generation device 2018 (e.g., a speaker), a network interface device 2020, and one or more sensors 2021, such as a Global Positioning System (GPS) sensor, compass, accelerometer, or another sensor. The machine 2000 may include an output controller 2028, such as a serial (e.g., universal serial bus (USB)), parallel, or other wired or wireless (e.g., infrared (IR), near field communication (NFC)) connection to communicate with or control one or more peripheral devices (e.g., a printer, card reader).

The processor 2002 refers to any one or more circuits or virtual circuits (e.g., a physical circuit emulated by logic executing on an actual processor) that manipulates data values according to control signals (e.g., commands, opcodes, machine code, control words, macroinstructions, etc.) and which produces corresponding output signals that are applied to operate a machine. A processor 2002 may, for example, include at least one of a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), a Tensor Processing Unit (TPU), a Neural Processing Unit (NPU), a Vision Processing Unit (VPU), a Machine Learning Accelerator, an Artificial Intelligence Accelerator, an Application Specific Integrated Circuit (ASIC), a Field Programmable Gate Array (FPGA), a Radio-Frequency Integrated Circuit (RFIC), a Neuromorphic Processor, a Quantum Processor, or any combination thereof.

The processor 2002 may further be a multi-core processor having two or more independent processors (sometimes referred to as “cores”) that may execute instructions contemporaneously. Multi-core processors contain multiple computational cores on a single integrated circuit die, each of which can independently execute program instructions in parallel. Parallel processing on multi-core processors may be implemented via architectures like superscalar, VLIW, vector processing, or SIMD that allow each core to run separate instruction streams concurrently. The processor 2002 may be emulated in software, running on a physical processor, as a virtual processor or virtual circuit. The virtual processor may behave like an independent processor but is implemented in software rather than hardware.

The mass storage device 2016 may include a machine-readable medium 2022 on which one or more sets of data structures or instructions 2024 (e.g., software) embodying or utilized by any of the techniques or functions described herein. The instructions 2024 may also reside, completely or at least partially, within the main memory 2004, within the static memory 2006, within the hardware processor 2002, or the GPU 2003 during execution thereof by the machine 2000. For example, one or any combination of the hardware processor 2002, the GPU 2003, the main memory 2004, the static memory 2006, or the mass storage device 2016 may constitute machine-readable media.

While the machine-readable medium 2022 is illustrated as a single medium, the term “machine-readable medium” may include a single medium or multiple media (e.g., a centralized or distributed database and associated caches and servers) configured to store one or more instructions 2024.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

The term “machine-readable medium” may include any medium that is capable of storing, encoding, or carrying instructions 2024 for execution by the machine 2000 and that causes the machine 2000 to perform any one or more of the techniques of the present disclosure or that is capable of storing, encoding, or carrying data structures used by or associated with such instructions 2024. Non-limiting machine-readable medium examples may include solid-state memories and optical and magnetic media. For example, a massed machine-readable medium comprises a machine-readable medium 2022 with a plurality of particles having invariant (e.g., rest) mass. Accordingly, massed machine-readable media are not transitory propagating signals. Specific examples of massed machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

As used herein, the terms “machine-storage medium,” “device-storage medium,” and “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate arrays (FPGAs), and flash memory devices; magnetic disks such as internal hard disks and removable disks; magneto-optical disks; and CD-ROM and DVD-ROM disks. The terms “machine-storage medium,” “computer-storage medium,” and “device-storage medium” specifically exclude carrier waves, modulated data signals, and other such media.

The instructions 2024 may be transmitted or received over a communications network 2026 using a transmission medium via the network interface device 2020. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 2024 for execution by the machine 2000, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented separately. These and other variations, modifications, additions, and improvements fall within the scope of the subject matter herein.

The examples illustrated herein are described in sufficient detail to enable those skilled in the art to practice the teachings disclosed. Other examples may be used and derived therefrom, such that structural and logical substitutions and changes may be made without departing from the scope of this disclosure. The Detailed Description, therefore, is not to be taken in a limiting sense, and the scope of various examples is defined only by the appended claims, along with the full range of equivalents to which such claims are entitled.

Additionally, as used in this disclosure, phrases of the form “at least one of an A, a B, or a C,” “at least one of A, B, and C,” and the like should be interpreted to select at least one from the group that comprises “A, B, and C.” Unless explicitly stated otherwise in connection with a particular instance, in this disclosure, this manner of phrasing does not mean “at least one of A, at least one of B, and at least one of C.” As used in this disclosure, the example “at least one of an A, a B, or a C” would cover any of the following selections: {A}, {B}, {C}, {A, B}, {A, C}, {B, C}, and {A, B, C}.

Moreover, plural instances may be provided for resources, operations, or structures described herein as a single instance. Additionally, boundaries between various resources, operations, modules, engines, and data stores are somewhat arbitrary, and particular operations are illustrated in the context of specific illustrative configurations. Other allocations of functionality are envisioned and may fall within the scope of various examples of the present disclosure. In general, structures and functionality are presented as separate resources in the example; configurations may be implemented as a combined structure or resource. Similarly, structures and functionality presented as a single resource may be implemented as separate resources. These and other variations, modifications, additions, and improvements fall within the scope of examples of the present disclosure as represented by the appended claims. Accordingly, the specification and drawings are to be regarded in an illustrative rather than a restrictive sense.

What is claimed is:

1. A data security system (DSS) comprising:
a storage media;
an interface controller coupled to the storage media, the interface controller configured to enable access to the storage media when the DSS is unlocked;
an authentication controller coupled to the interface controller, the authentication controller configured to authenticate a user to unlock the DSS; and
an electronic switch controlled by the authentication controller, the electronic switch connecting an external data channel of the DSS to one of the authentication controller or the interface controller;
wherein the authentication controller sets the electronic switch for communication to the authentication controller when the DSS is locked, wherein the authentication controller is configured to receive authentication information to unlock the DSS from a host via the external data channel, wherein the authentication controller sets the electronic switch for communication to the interface controller after the DSS is unlocked to enable access to the storage media from the host via the external data channel and the electronic switch.

2. The DSS recited in claim 1, wherein the authentication controller is configured to receive authentication information via the external data channel when the DSS is locked.

3. The DSS as recited in claim 2, wherein the authentication information, received via the external data channel, comprises user identifier and a Personal Identification Number (PIN).

4. The DSS as recited in claim 2, wherein an application executing on the host includes options for authenticating the user, wherein the authentication controller communicates with the application via the external data channel.

5. The DSS as recited in claim 4, wherein the application is configured to communicate with the authentication controller to manage user and administrator credentials and DSS configuration parameters.

6. The DSS as recited in claim 4, wherein the application communicates with a server to authenticate a user based on information provided by the user, wherein the authentication controller is configured to receive authentication validation originated at the server after the server authenticates the user based on the information provided by the user in the application.

7. The DSS as recited in claim 6, wherein the application is configured to communicate with the authentication controller and the server to manage user and administrator credentials and DSS configuration parameters.

8. The DSS as recited in claim 1, wherein the DSS further comprises:
a radiofrequency (RF) transceiver coupled to the authentication controller, wherein the authentication controller comprises logic for double authentication using information received from the host via the external data channel and information received via the RF transceiver.

9. The DSS as recited in claim 1, wherein the DSS further comprises:
a biometric sensor coupled to the authentication controller, wherein the authentication controller comprises logic for double authentication using information received from the host via the external data channel and information received via the biometric sensor.

10. The DSS as recited in claim 1, wherein the DSS further comprises:
an electro-mechanical input mechanism coupled to the authentication controller, wherein the authentication controller comprises logic for double authentication using information received from the host via the external data channel and information received via the electro-mechanical input mechanism.

11. The DSS as recited in claim 1, wherein the DSS further comprises:
a radiofrequency (RF) transceiver coupled to the authentication controller; and
an electro-mechanical input mechanism coupled to the authentication controller, wherein the authentication controller comprises logic for double authentication using information received from a mobile device via the RF transceiver and information received via the electro-mechanical input mechanism.

12. The DSS as recited in claim 1, wherein the authentication controller is configured to lock the DSS after receiving a request to lock the DSS via an RF transceiver, a biometric sensor, or an electro-mechanical input mechanism.

13. The DSS as recited in claim 1, wherein the authentication controller is configured to lock the DSS in response to the DSS being disconnected from the host.

14. A method comprising:
configuring, by an authentication controller in a data security system (DSS), an electronic switch in the DSS to connect an external data channel of the DSS to the authentication controller when the DSS is locked;
receiving, by the authentication controller, authentication information to unlock the DSS from a host connected to the external data channel;
unlocking, by the authentication controller, the DSS based on the authentication information; and
setting, by the authentication controller, in response to the unlocking, the electronic switch to connect the external data channel to an interface controller coupled to a storage media to enable access to the storage media from the host via the external data channel.

15. The method as recited in claim 14, wherein the authentication controller is configured to receive the authentication information via the external data channel when the DSS is locked.

16. The method as recited in claim 14, wherein the authentication information, received via the external data channel, comprises a Personal Identification Number (PIN).

17. The method as recited in claim 14, wherein an application executing on the host includes options for authenticating a user, wherein the authentication controller communicates with the application via the external data channel.

18. The method as recited in claim 17, wherein the application communicates with a server to authenticate a user based on information provided by the user, wherein the authentication controller is configured to receive authentication validation originated at the server after the server authenticates the user based on the information provided by the user in the application.

19. The method as recited in claim 14, wherein the DSS further comprises a radiofrequency (RF) transceiver coupled to the authentication controller, wherein the authentication controller comprises logic for double authentication using information received from the host via the external data channel and information received via the RF transceiver.

20. A machine-storage medium including instructions that, when executed by a machine, cause the machine to perform operations comprising:
configuring, by an authentication controller in a data security system (DSS), an electronic switch in the DSS to connect an external data channel of the DSS to the authentication controller when the DSS is locked;
receiving, by the authentication controller, authentication information to unlock the DSS from a host connected to the external data channel;
unlocking, by the authentication controller, the DSS based on the authentication information; and
setting, by the authentication controller, in response to the unlocking, the electronic switch to connect the external data channel to an interface controller coupled to a storage media to enable access to the storage media from the host via the external data channel.
